(19) United States
(12) Patent Application Publication
(10) Pub. No.: US 2026/0016350 A1
(43) Pub. Date: Jan. 15, 2026

(54) FORCE SENSOR

(71) Applicant: Infineon Technologies AG, Neubiberg (DE)

(72) Inventor: Udo AUSSERLECHNER, Villach (AT)

(21) Appl. No.: 18/771,272

(22) Filed: Jul. 12, 2024

(51) Int. Cl. G01L 1/16; G01L 1/22

(52) U.S. Cl. CPC G01L 1/16; G01L 1/2293

(57) ABSTRACT

A sensor system includes a force sensor including a force sensor chip made of a cubic semiconductor single crystal, and a measurement circuit; and a strain body configured to undergo a body deformation in response to an external mechanical force applied to the strain body, wherein the strain body is mechanically coupled to the force sensor chip in such a way as to couple the external mechanical force to the force sensor chip to strain the force sensor chip mainly along a primary strain direction. The force sensor chip includes a pair of piezo-resistive devices integrated in the force sensor chip. The pair of piezo-resistive devices are configured to respond differently to a strain along the primary strain direction. The measurement circuit is configured to measure the external mechanical force based on one or more currents flowing through the pair of piezo-resistive devices.

### BACKGROUND

A strain gauge is a sensor whose measured electrical resistance varies with changes in strain. Strain is the deformation or displacement of material that results from an applied stress (e.g., an applied mechanical force) or from thermal expansion. Thus, a strain gauge is a device used to measure strain on an object. To this end, the strain gauge is rigidly attached to the object. As the object is deformed, the strain gauge is deformed, causing the electrical resistance of the strain gauge to change. The change in electrical resistance is related to the strain by the quantity known as a gauge factor.

### SUMMARY

In some implementations, a sensor system includes a force sensor comprising: a force sensor chip made of a cubic semiconductor single crystal; and a measurement circuit; and a strain body configured to undergo a body deformation in response to an external mechanical force applied to the strain body, wherein the strain body is mechanically coupled to the force sensor chip in such a way as to couple the external mechanical force to the force sensor chip to strain the force sensor chip mainly along a primary strain direction, wherein the force sensor chip comprises: a first pair of piezo-resistive devices integrated in the force sensor chip, wherein the first pair of piezo-resistive devices are arranged such that first current paths through the first pair of piezo-resistive devices are not parallel or anti-parallel to each other, and wherein the first pair of piezo-resistive devices are configured to respond differently to a strain along the primary strain direction, wherein the measurement circuit is configured to measure the external mechanical force based on one or more currents flowing through the first pair of piezo-resistive devices, and wherein each piezo-resistive device of the first pair of piezo-resistive devices has holes as majority carriers, and a <110> crystal direction of the force sensor chip is aligned within +/−35° to a line that is parallel to the primary strain direction, or wherein each piezo-resistive device of the first pair of piezo-resistive devices has electrons as the majority carriers, and a <100> crystal direction of the force sensor chip is aligned within +/−35° to the line that is parallel to the primary strain direction.

In some implementations, a sensor system includes a force sensor chip made of a cubic semiconductor single crystal; and a strain body configured to undergo a body deformation in response to an external mechanical force applied to the strain body, wherein the strain body is mechanically coupled to the force sensor chip in such a way as to couple the external mechanical force to the force sensor chip to strain the force sensor chip mainly along a primary strain direction, wherein the force sensor chip comprises: a first pair of piezo-resistive devices integrated in the force sensor chip, wherein the first pair of piezo-resistive devices are arranged such that first current paths through the first pair of piezo-resistive devices are not parallel or anti-parallel to each other, and wherein the first pair of piezo-resistive devices respond differently to a strain along the primary strain direction; a second pair of piezo-resistive devices integrated in the force sensor chip, wherein the second pair of piezo-resistive devices are arranged such that second current paths through the second pair of piezo-resistive devices are not parallel or anti-parallel to each other, and wherein the second pair of piezo-resistive devices respond differently to the strain along the primary strain direction; and a measurement circuit configured to measure the external mechanical force based on at least one of: one or more first currents flowing through the first pair of piezo-resistive devices, or one or more second currents flowing through the second pair of piezo-resistive devices, wherein each piezo-resistive device of the first pair of piezo-resistive devices has holes as majority carriers, wherein each piezo-resistive device of the second pair of piezo-resistive devices has electrons as the majority carriers.

In some implementations, a force sensor chip includes a cubic semiconductor single crystal, wherein the cubic semiconductor single crystal is configured to undergo a chip deformation based on an external mechanical force applied to a deformable member to which the force sensor chip is configured to be mechanically coupled in such a way as to couple the external mechanical force to the cubic semiconductor single crystal to strain the cubic semiconductor single crystal mainly along a primary strain direction; a first pair of piezo-resistive devices integrated in the cubic semiconductor single crystal, wherein the first pair of piezo-resistive devices are arranged such that first current paths through the first pair of piezo-resistive devices are not parallel or anti-parallel to each other, and wherein the first pair of piezo-resistive devices respond differently to an in-plane mechanical strain caused by a chip deformation of the cubic semiconductor single crystal; and a measurement circuit configured to measure the external mechanical force based on one or more currents flowing through the first pair of piezo-resistive devices, wherein each piezo-resistive device of the first pair of piezo-resistive devices has holes as majority carriers, and a <110> crystal direction of the cubic semiconductor single crystal is configured to be aligned within +/−35° to a line that is parallel to the primary strain direction, or wherein each piezo-resistive device of the first pair of piezo-resistive devices has electrons as the majority carriers, and a <100> crystal direction of the cubic semiconductor single crystal is configured to be aligned within +/−35° to the line that is parallel to the primary strain direction.

In some implementations, a force sensor chip includes a cubic semiconductor single crystal, wherein the cubic semiconductor single crystal is configured to undergo a chip deformation based on an external mechanical force applied to a deformable member to which the force sensor chip is configured to be mechanically coupled in such a way as to couple the external mechanical force to the cubic semiconductor single crystal to strain the cubic semiconductor single crystal mainly along a primary strain direction; a first pair of piezo-resistive devices integrated in the cubic semiconductor single crystal, wherein the first pair of piezo-resistive devices are arranged such that first current paths through the first pair of piezo-resistive devices are not parallel or anti-parallel to each other, and wherein the first pair of piezo-resistive devices respond differently to an in-plane mechanical strain caused by the chip deformation; a second pair of piezo-resistive devices integrated in the cubic semiconductor single crystal, wherein the second pair of piezo-resistive devices are arranged such that second current paths through the second pair of piezo-resistive devices are not parallel or anti-parallel to each other, and wherein the second pair of piezo-resistive devices respond differently to the in-plane mechanical strain caused by a chip deformation of the cubic semiconductor single crystal; and a measurement circuit configured to measure the external mechanical force based on one or more first currents flowing through the first pair of piezo-resistive devices, and based on one or more second currents flowing through the second pair of piezo-resistive devices, wherein each piezo-resistive device of the first pair of piezo-resistive devices has holes as majority carriers, wherein each piezo-resistive device of the second pair of piezo-resistive devices has electrons as the majority carriers.

### BRIEF DESCRIPTION OF THE DRAWINGS

Implementations are described herein with reference to the appended drawings.

FIG. 1A illustrates a side view and a top view of a sensor system according to one or more implementations.

FIG. 1B illustrates a force sensor chip according to one or more implementations.

FIG. 2A illustrates a side view and a top view of a sensor system according to one or more implementations.

FIG. 2B illustrates a force sensor chip according to one or more implementations.

FIG. 3 illustrates a side view and a top view of a sensor system according to one or more implementations.

FIG. 4 illustrates a force sensor according to one or more implementations.

FIG. 5 illustrates a force sensor according to one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view, rather than in detail, in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually interchangeable.

Each of the illustrated x-axis, y-axis, and z-axis is substantially perpendicular to the other two axes. In other words, the x-axis is substantially perpendicular to the y-axis and the z-axis, the y-axis is substantially perpendicular to the x-axis and the z-axis, and the z-axis is substantially perpendicular to the x-axis and the y-axis. In some cases, a single reference number is shown to refer to a surface, or fewer than all instances of a part may be labeled with all surfaces of that part. All instances of the part may include associated surfaces of that part despite not every surface being labeled.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “top,” “bottom,” “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling (e.g., any connection or coupling without additional intervening elements) may also be implemented by an indirect connection or coupling (e.g., a connection or coupling with one or more additional intervening elements, or vice versa) as long as the general purpose of the connection or coupling (e.g., to transmit a certain kind of signal or to transmit a certain kind of information) is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, a signal with an approximate signal value may practically have a signal value within 5% of the approximate signal value.

In the present disclosure, expressions including ordinal numbers, such as “first”, “second”, and/or the like, may modify various elements. However, such elements are not limited by such expressions. For example, such expressions do not limit the sequence and/or importance of the elements. Instead, such expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

“Sensor” may refer to a component which converts a property to be measured to an electrical signal (e.g., a current signal or a voltage signal). The property to be measured may, for example, comprise a magnetic field, an electric field, an electromagnetic wave (e.g., a radio wave), a pressure, a force, a current, or a voltage, but is not limited thereto. For a force sensor, the property to be measured is a strain produced, for example, by a mechanical force. A strain gauge is one type of force sensor. However, attaching strain gauges to a compliant mechanical part can be difficult and unreliable. In addition, signals sensed from strain gauges are small (e.g., micro-volts) and are susceptible to temperature drift, which can cause inaccurate measurements. The compliant mechanical part may be a deformable member, such as a strain body, that deforms when an external mechanical force is applied to the compliant mechanical part. The compliant mechanical part may be a leaf spring, or other spring-compliant member.

Some implementations disclosed herein are directed to a force sensor chip made of a cubic semiconductor single crystal attached to a compliant mechanical part. The cubic semiconductor may be silicon or another type of cubic semiconductor, such as germanium. The force sensor chip may have a micro-electronic device that detects a strain of the compliant mechanical part and provides one or more sensor signals representative of an external mechanical force that is applied to the compliant mechanical part. A sensor circuit (e.g., a measurement circuit) may be provided that processes, calibrates, and/or trims the one or more sensor signals, and outputs one or more processed sensor signals via an interface (e.g., a digital interface or an analog interface). The sensor circuit may also comprise a nonvolatile memory to store calibration data and/or configuration data and/or identification data of the sensor chip and/or circuit. For example, the nonvolatile memory may store information on electric parameters of at least one of the piezo-resistive devices, such as a sheet resistance or a transistor current gain, a piezo-resistive constant of the resistance or a piezo-resistive constant the transistor current gain, a mismatch of orthogonal resistances or current gains, a temperature coefficient of the resistance or a temperature coefficient the current gain, and/or a temperature coefficient of the piezo-coefficient of the resistance or a temperature coefficient of the piezo-coefficient the current gain). Additionally, the micro-electronic device may generate monitoring signals to assess a reliability of the force sensor chip, including assessing a temperature, whether the external mechanical force is outside a range (e.g., a force-out-of-range signal), whether the external mechanical force is abrupt (e.g., a fast threshold detection of force), and/or detecting a delamination of the force sensor chip from the compliant mechanical part. Moreover, the force sensor chip may include two or more types of force sensor elements that rely on different sensing principles, which may provide functional safety and reliability through redundancy and/or error detection.

During manufacturing, the force sensor chip may be cut out of a wafer, and the wafer may be cut out of a single crystal ingot. Therefore, the force sensor chip may be a piece of single crystal. A cubic crystal, such as a silicon crystal, has <100> crystal directions. In contrast, hexagonal crystals do not have <100> crystal directions. The <100> crystal directions are parallel to the edges of a unit cell of the cubic crystal.

Crystal orientation is defined by Miller indices h, k, and l, and determines wafer properties. There are several related notations. First, a notation (hkl) denotes a specific lattice plane of a crystal lattice. Second, a notation {hkl} denotes a set of all lattice planes that are equivalent to (hkl) by a symmetry of the crystal lattice. Third, in a context of crystal directions (not planes), a notation [hkl], with square brackets instead of round brackets, denotes a specific crystal direction (e.g., a direct lattice vector). Fourth, in the context of crystal directions (not planes), a notation <hkl> denotes a set of all crystal directions that are equivalent to [hkl] by the symmetry of the crystal lattice. For example, <110> means all equivalent permutations (e.g., reciprocals) of crystal directions in a cubic crystal (e.g., cubic symmetry), which includes both [110] and [−110] crystal directions. In contrast, [110] means exactly this individual crystal direction.

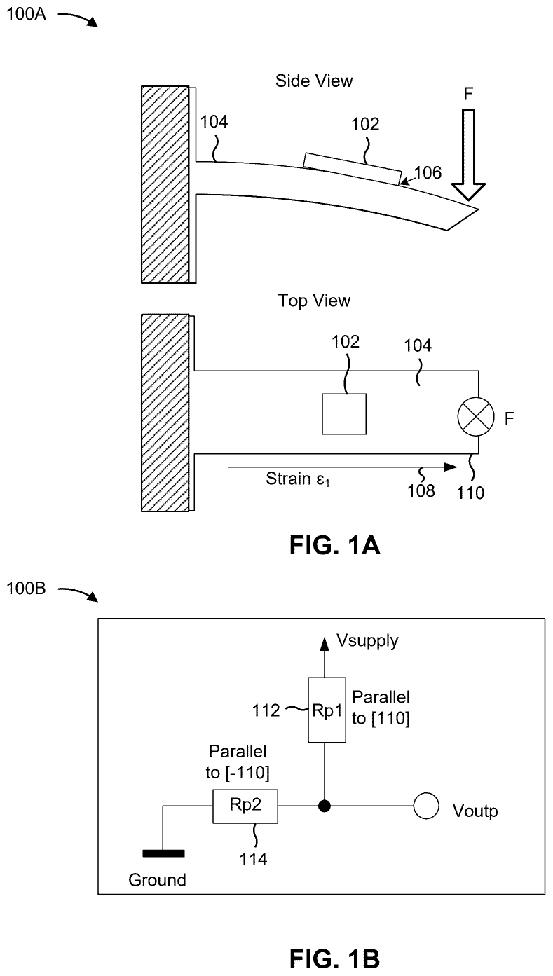

FIG. 1A illustrates a side view and a top view of a sensor system 100A according to one or more implementations. The sensor system 100A includes a force sensor 102 and a strain body 104. The force sensor 102 may include a force sensor chip made of a cubic semiconductor single crystal, and a measurement circuit. In some implementations, the measurement circuit may be integrated in the force sensor chip. In some implementations, the measurement circuit may be integrated in a second chip of the force sensor 102. In some implementations, the force sensor chip may be the force sensor 102.

The strain body 104 may be a deformable member, such as a leaf spring, that is configured to undergo a body deformation in response to an external mechanical force F applied to the strain body 104. The strain body 104 may be mechanically coupled to the force sensor chip, for example, by a die attach layer 106, in such a way as to couple the external mechanical force F to the force sensor chip to strain the force sensor chip mainly along a primary strain direction 108. Thus, a substrate of the force sensor chip (e.g., the cubic semiconductor single crystal) may be attached to the strain body 104.

A strain along the primary strain direction 108 may be referred to as a first principal strain ε1 and may represent a dominant strain within the strain body 104 that is resultant from the external mechanical force F being applied to the strain body 104. A second principal strain ε2 in a second strain direction and a third principal strain ε3 in a third strain direction that are mutually orthogonal with the primary strain direction 108 may also be present. However, the first principal strain ε1 is greater than the second principal strain ε2 and the third principal strain ε3. As a result, the strain body 104 may be mechanically coupled to the force sensor chip in such a way that the body deformation of the strain body 104 causes a largest principal strain component of the force sensor chip to occur along the primary strain direction 108. The primary strain direction 108 may be parallel to a long edge 110 of the strain body 104.

The force sensor chip may include a first pair of piezo-resistive devices integrated in the force sensor chip. The first pair of piezo-resistive devices may be arranged such that first current paths through the first pair of piezo-resistive devices are not parallel or anti-parallel to each other. For example, the first current paths may be orthogonal to each other. In addition, the first current paths may be parallel to a {100} plane of the force sensor chip. The strain body 104 may have a length dimension and a width dimension. The primary strain direction 108 may be along the length dimension. In addition, the width dimension and the length dimension may define a lateral chip plane of the force sensor chip (e.g., the {100} plane), and the first current paths may be aligned with the lateral chip plane. The first pair of piezo-resistive devices may be configured to respond differently to a strain along the primary strain direction 108. A doping profile of both devices of the first pair of piezo-resistive devices may be identical (e.g., not only of the same doping type, namely p-type, but also having a same magnitude).

The measurement circuit may measure the external mechanical force F applied to the strain body 104 based on one or more currents flowing through the first pair of piezo-resistive devices. In addition, each piezo-resistive device of the first pair of piezo-resistive devices may have holes as majority carriers, and a <110> crystal direction of the force sensor chip may be aligned within +/−35° to a line that is parallel to the primary strain direction 108. In some implementations, the <110> crystal direction of the force sensor chip may be aligned within +/−20°, within +/−15°, or within +/−10° to a line that is parallel to the primary strain direction 108. In some implementations, the <110> crystal direction of the force sensor chip is aligned with the line that is parallel to the primary strain direction 108. Either the <100> crystal directions or the <110> crystal directions of the single crystal of the force sensor chip are parallel or antiparallel to chip edges of the force sensor chip (depending on if the wafer is rotated {100} type material or ordinary, conventional {100} type material, respectively). The measurement circuit may include a nonvolatile memory to store calibration data and/or configuration data and/or identification data of the force sensor chip and/or circuit.

The first pair of piezo-resistive devices, which have holes as majority carriers, are p-doped devices. In some implementations, the first pair of piezo-resistive devices includes a first p-doped piezo-resistor configured to conduct a current in a [110] crystal direction of the force sensor chip, and a second p-doped piezo-resistor configured to conduct the current in a [−110] crystal direction of the force sensor chip. “p-doping” means doping with acceptor atoms (mainly from group III in the periodic system of elements in group IV semiconductors like silicon and germanium,).

A piezo-resistor is a resistor made of semiconductor material that has an electrical resistivity based on a piezoresistive effect. A voltage across two terminals of the piezo-resistor is roughly proportional to a current flowing through the piezo-resistor, according to Ohm's Law. The piezo-resistors may be stripes or meanders. Thus, the piezo-resistors may extend mainly in a certain crystal direction such that a major portion of a voltage drop across a piezo-resistor occurs along the crystal direction.

The current conducted by the first p-doped piezo-resistor and the current conducted by the second p-doped piezo-resistor may change by different amounts based on the strain along the primary strain direction 108. For example, resistances of the first p-doped piezo-resistor and the second p-doped piezo-resistor may change by different amounts based on the strain along the primary strain direction 108, which can affect an amount of current that flows through each of the first p-doped piezo-resistor and the second p-doped piezo-resistor and/or a voltage drop across each of the first p-doped piezo-resistor and the second p-doped piezo-resistor. The first pair of piezo-resistive devices may form a voltage divider configured to generate an electric potential at a node coupled between the first pair of piezo-resistive devices, and the measurement circuit may measure the external mechanical force applied to the strain body 104 based on the electric potential of this node. Since the resistances of the first p-doped piezo-resistor and the second p-doped piezo-resistor and the currents conducted by the first p-doped piezo-resistor and the second p-doped piezo-resistor depend on the strain along the primary strain direction 108, the electric potential also depends on the strain along the primary strain direction 108. The external mechanical force may be proportional to the strain along the primary strain direction 108.

In some implementations, the force sensor chip may include a second pair of piezo-resistive devices. Thus, the second pair of piezo-resistive devices may be integrated in the force sensor chip. The second pair of piezo-resistive devices may have a same type of majority carrier as the first pair of piezo-resistive devices and may have similar current path orientations as the first pair of piezo-resistive devices. The second pair of piezo-resistive devices may be arranged such that second current paths through the second pair of piezo-resistive devices are not parallel or anti-parallel to each other. In addition, the second pair of piezo-resistive devices respond differently to the strain along the primary strain direction. The first pair of piezo-resistive devices and the second pair of piezo-resistive devices may be coupled in a Wheatstone bridge configuration. For example, the first pair of piezo-resistive devices may be a first pair of orthogonal lateral piezo-resistors, and the second pair of piezo-resistive devices may be a second pair of orthogonal lateral piezo-resistors. The first pair of piezo-resistive devices may form a first half-bridge of a Wheatstone bridge, and the second pair of piezo-resistive devices may form a second half-bridge of a Wheatstone bridge. The measurement circuit may measure the external mechanical force applied to the strain body 104 based on a differential output (e.g., an electric potential difference) of the Wheatstone bridge.

In some implementations, the first pair of piezo-resistive devices may be transistors, such as metal-oxide-semiconductor field-effect transistors (MOSFETs), junction field-effect transistors (JFETs), or bipolar junction transistors (BJTs). For example, the first pair of piezo-resistive devices may include a first P-MOSFET (e.g., a P-channel MOSFET) configured to conduct a first current in a first <110> crystal direction of the force sensor chip, and a second P-MOSFET configured to conduct a second current in a direction orthogonal to the first <110> crystal direction of the force sensor chip. The first current and the second current may change by different amounts based on the strain along the primary strain direction 108. For example, the first P-MOSFET and the second P-MOSFET may be arranged as a current mirror with a mirror ratio=Iout/Iin, where Iin denotes the first current and Iout denotes the second current. The mirror ratio may depend on mechanical stress or strain acting on the first P-MOSFET and the second P-MOSFET when the drain-source directions of the first P-MOSFET and the second P-MOSFET are perpendicular. Alternatively, the first P-MOSFET and the second P-MOSFET may be arranged as a differential input pair (e.g., as inputs to an operational amplifier (OpAmp) or an operational transconductance amplifier (OTA)). Thus, P-MOSFET transistors may be used to detect a difference of in-plane normal stresses. The measurement circuit may determine the external mechanical force based on a ratio of the first current and the second current or based on a difference between the first current and the second current.

In some implementations, the force sensor chip may include a second pair of piezo-resistive devices. Thus, the second pair of piezo-resistive devices may be integrated in the force sensor chip. The second pair of piezo-resistive devices may have a same type of majority carrier as the first pair of piezo-resistive devices and may have similar current path orientations as the first pair of piezo-resistive devices. The second pair of piezo-resistive devices may be arranged such that second current paths through the second pair of piezo-resistive devices are not parallel or anti-parallel to each other. In addition, the second pair of piezo-resistive devices respond differently to the strain along the primary strain direction. The first pair of piezo-resistive devices and the second pair of piezo-resistive devices may be coupled in a Wheatstone bridge configuration. For example, the first pair of piezo-resistive devices may be a first pair of orthogonal lateral piezo-resistors, and the second pair of piezo-resistive devices may be a second pair of orthogonal lateral piezo-resistors. The first pair of piezo-resistive devices may form a first half-bridge of a Wheatstone bridge, and the second pair of piezo-resistive devices may form a second half-bridge of a Wheatstone bridge.

In some implementations, a temperature-dependent power supply may be coupled to the first pair of piezo-resistive devices. The temperature-dependent power supply may provide a supply voltage or a supply current based on an ambient temperature such that a measure of the external mechanical force applied to the strain body 104 compensates for the ambient temperature. The temperature-dependent power supply may include a bandgap circuit that may generate a temperature-dependent voltage or a temperature-dependent current based on the ambient temperature. Most piezo-resistive coefficients have a negative temperature coefficient of roughly −3.4×10⁻³/° C. Therefore, it may be advantageous to use a supply voltage of piezo-resistive bridge circuits or a supply current of MOSFET current mirrors and MOSFET differential input pairs that has a same temperature coefficient, but with opposite sign (e.g., +3.4×10⁻³/° C.). In other words, the temperature coefficient of the temperature-dependent power supply may be equal but opposite in sign to the temperature coefficient of the first pair and/or second pair of piezo-resistive devices. It may be advantageous to trim the temperature coefficient of the supply voltage or the supply current of the bridge circuits and to store this temperature coefficient in a nonvolatile memory on the chip. The trimming can be done prior, during, or after wafer test or end test of the chip manufacturing or prior, during, or after installation of the chip on the deformation body. A mismatch of resistances or current gains of MOSFETs can also be trimmed off during wafer level or end test of the chip manufacturing and stored in the nonvolatile memory.

As indicated above, FIG. 1A is provided as an example. Other examples may differ from what is described with regard to FIG. 1A. The number and arrangement of components shown in FIG. 1A are provided as an example. In practice, the sensor system 100A may include additional components, fewer components, different components, or differently arranged components than those shown in FIG. 1A. Two or more components shown in FIG. 1A may be implemented within a single component, or a single component shown in FIG. 1A may be implemented as multiple, distributed components. Additionally, or alternatively, a set of components (e.g., one or more components) of the sensor system 100A may perform one or more functions described as being performed by another set of components of the sensor system 100A.

FIG. 1B illustrates a force sensor chip 100B according to one or more implementations. The force sensor chip 100B may be implemented in the force sensor 102 of the sensor system 100A described in connection with FIG. 1A.

A <110> crystal direction of the force sensor chip 100B is aligned within +/−35° to a line that is parallel to the primary strain direction 108 shown in FIG. 1A. Moreover, either the <100> crystal directions or the <110> crystal directions of the force sensor chip 100B are parallel or antiparallel to chip edges of the force sensor chip 100B.

The force sensor chip 100B includes a pair of piezo-resistive devices, which have holes as majority carriers, that are p-doped devices. The pair of piezo-resistive devices may include a first p-doped piezo-resistor 112 configured to conduct a current in a [110] crystal direction of the force sensor chip 100B, and a second p-doped piezo-resistor 114 configured to conduct the current in a [−110] crystal direction of the force sensor chip 100B. The first p-doped piezo-resistor 112 may have a first strain-dependent resistance Rp1, and the second p-doped piezo-resistor 114 may have a second strain-dependent resistance Rp2. Thus, the first p-doped piezo-resistor 112 and the second p-doped piezo-resistor 114 may form a voltage divider. The first strain-dependent resistance Rp1 and the second strain-dependent resistance Rp2 may change by different amounts based on the strain along the primary strain direction. Thus, a voltage drop across each of the first p-doped piezo-resistor 112 and the second p-doped piezo-resistor 114 may change by different amounts based on the strain along the primary strain direction.

The measurement circuit may measure the external mechanical force applied to the strain body 104 based on an electric potential Voutp at an output node of the voltage divider. The electric potential Voutp may be equal to Vsupply×Rp2/(Rp1+Rp2), where Vsupply is a voltage supply to the voltage divider. The measurement circuit may include a processing circuit configured to calculate the strain and/or the external mechanical force based on the electric potential Voutp. For example, the measurement circuit may sample a value of the electric potential Voutp, and calculate the strain and/or the external mechanical force based on a predefined formula. Thus, the measurement circuit may include at least one processor configured to perform calculations. In some implementations, the measurement circuit may include an analog-to-digital converter (ADC) configured to convert the electric potential Voutp into a digital value, and digital processing circuitry used to perform the calculations. The measurement circuit may include a nonvolatile memory to store calibration data and/or configuration data and/or identification data of the force sensor chip and/or circuit. The data stored in the nonvolatile memory may be used to determine the strain and/or the external mechanical force.

In some implementations, the measurement circuit may detect a delamination of the force sensor chip from the strain body based on the electric potential Voutp. For example, multiple sensor pairs of piezo-resistive devices may be placed in different locations on the strain body. If the force sensor chip delaminates, it means that there is a void in the die attach layer 106 and the sensor pair above this void will detect notably different stress/strain than all other sensor pairs. Thus, the measurement circuit may monitor the stress/strain of all sensor pairs and detect a delamination based on any of the sensor pairs detecting a notably different stress/strain than all other sensor pairs (e.g., if the stress/strain deviates from a mean of the other sensor pairs by a threshold amount).

As indicated above, FIG. 1B is provided as an example. Other examples may differ from what is described with regard to FIG. 1B.

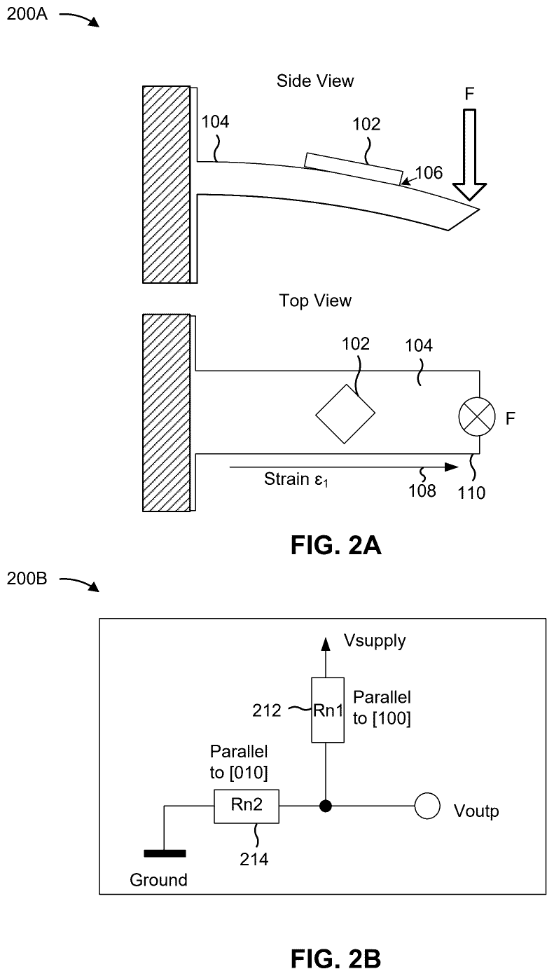

FIG. 2A illustrates a side view and a top view of a sensor system 200A according to one or more implementations. The sensor system 200A may be similar to the sensor system 100A described in connection with FIGS. 1A and 1B, with an exception that each piezo-resistive device of the first pair of piezo-resistive devices has electrons as the majority carriers, and a <100> crystal direction of the force sensor chip is aligned within +/−35° to a line that is parallel to the primary strain direction 108. In some implementations, the <100> crystal direction of the force sensor chip may be aligned within +/−20°, within +/−15°, or within +/−10° to a line that is parallel to the primary strain direction 108. In some implementations, the <100> crystal direction of the force sensor chip is aligned with the line that is parallel to the primary strain direction 108. As a result of the first pair of piezo-resistive devices having electrons as the majority carriers, an orientation of the force sensor chip in sensor system 200A is different from an orientation of the force sensor chip in sensor system 100A. A doping profile of both devices of the first pair of piezo-resistive devices may be identical (e.g., not only of the same doping type, namely n-type, but also having a same magnitude).

In some implementations, the first pair of piezo-resistive devices, which have electrons as majority carriers, are n-doped devices. “n-doping” means doping with donator atoms (mainly from group V in the periodic system of elements for group IV semiconductor substrates). The first pair of piezo-resistive devices may include a first n-doped piezo-resistor configured to conduct the current in a [100] crystal direction of the force sensor chip, and a second n-doped piezo-resistor configured to conduct the current in a [010] crystal direction of the force sensor chip.

In some implementations, a first pair of piezo-resistive devices includes a first N-MOSFET (e.g., an N-channel MOSFET) configured to conduct the first current in a first <100> crystal direction of the force sensor chip, and a second N-MOSFET configured to conduct the second current in a direction orthogonal to the first <100> crystal direction of the force sensor chip. The first pair of piezo-resistive devices may include a first N-MOSFET configured to conduct a first current, and a second N-MOSFET configured to conduct a second current. The measurement circuit may be configured to determine the external mechanical force applied to the strain body 104 based on a ratio of the first current and the second current or based on a difference between the first current and the second current. In some implementations, the first pair of piezo-resistive devices (e.g., the N-MOSFETs) form a current mirror or a differential input pair. Other types of transistors, such as JFETs or BJTs may be used instead of MOSFETs.

As indicated above, FIG. 2A is provided as an example. Other examples may differ from what is described with regard to FIG. 2A.

FIG. 2B illustrates a force sensor chip 200B according to one or more implementations. The force sensor chip 200B may be implemented in the force sensor 102 of the sensor system 200A described in connection with FIG. 2A.

A <100> crystal direction of the force sensor chip 200B is aligned within +/−35° to a line that is parallel to the primary strain direction 108 shown in FIG. 2A. Moreover, either the <100A> crystal directions or the <110> crystal directions of the force sensor chip 200B are parallel or antiparallel to chip edges of the force sensor chip 200B.

The force sensor chip 100B includes a pair of piezo-resistive devices, which have electrons as majority carriers, that are n-doped devices. The first pair of piezo-resistive devices may include a first n-doped piezo-resistor 212 configured to conduct the current in a crystal direction of the force sensor chip 200B, and a second n-doped piezo-resistor configured to conduct the current in a [010] crystal direction of the force sensor chip 200B. The first n-doped piezo-resistor 212 may have a first strain-dependent resistance Rn1, and the second n-doped piezo-resistor 214 may have a second strain-dependent resistance Rn2. Thus, the first n-doped piezo-resistor 212 and the second n-doped piezo-resistor 214 may form a voltage divider. The first strain-dependent resistance Rn1, and the second strain-dependent resistance Rn2 may change by different amounts based on the strain along the primary strain direction. Thus, a voltage drop across each of the first n-doped piezo-resistor 212 and the second n-doped piezo-resistor 214 may change by different amounts based on the strain along the primary strain direction.

The measurement circuit may measure the external mechanical force based on an electric potential Voutn at an output node of the voltage divider. The electric potential Voutn may be equal to Vsupply×Rn2/(Rn1+Rn2). The measurement circuit may include a processing circuit configured to calculate the strain and/or the external mechanical force based on the electric potential Voutn. For example, the measurement circuit may sample a value of the electric potential Voutn, and calculate the strain and/or the external mechanical force based on a predefined formula. Thus, the measurement circuit may include at least one processor configured to perform calculations. In some implementations, the measurement circuit may include an ADC configured to convert the electric potential Voutn into a digital value, and digital processing circuitry used to perform the calculations.

In some implementations, the measurement circuit may detect a delamination of the force sensor chip from the strain body based on the electric potential Voutn. For example, multiple sensor pairs of piezo-resistive devices may be placed in different locations on the strain body. If the force sensor chip delaminates, it means that there is a void in the die attach layer 106 and the sensor pair above this void will detect notably different stress/strain than all other sensor pairs. Thus, the measurement circuit may monitor the stress/strain of all sensor pairs and detect a delamination based on any of the sensor pairs detecting a notably different stress/strain than all other sensor pairs (e.g., if the stress/strain deviates from a mean of the other sensor pairs by a threshold amount).

As indicated above, FIG. 2B is provided as an example. Other examples may differ from what is described with regard to FIG. 2B.

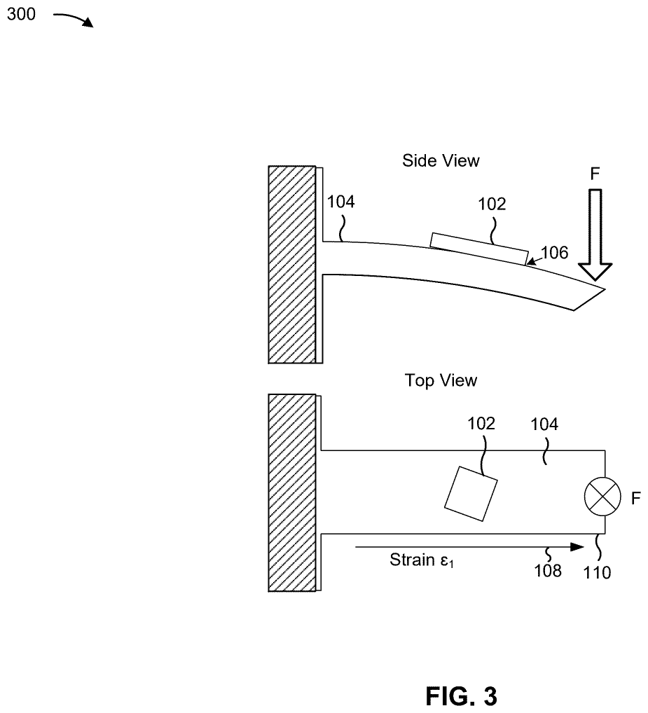

FIG. 3 illustrates a side view and a top view of a sensor system 300 according to one or more implementations. The sensor system 300 may be similar to the sensor system 100A described in connection with FIGS. 1A and 1B, with an exception that the force sensor chip includes two pairs of piezo-resistive devices (e.g., a first pair of piezo-resistive devices and a second pair of piezo-resistive devices) that have different majority carriers. The first pair of piezo-resistive devices may be integrated in the force sensor chip and may have holes as majority carriers. The second pair of piezo-resistive devices may be integrated in the force sensor chip and may have electrons as majority carriers.

The first pair of piezo-resistive devices may be arranged such that first current paths through the first pair of piezo-resistive devices are not parallel or anti-parallel to each other. In addition, the first pair of piezo-resistive devices may respond differently to a strain along the primary strain direction 108. Current paths of the first pair of piezo-resistive devices may be arranged similar to the first pair of piezo-resistive devices described in connection with FIG. 1A.

The second pair of piezo-resistive devices may be arranged such that second current paths through the second pair of piezo-resistive devices are not parallel or anti-parallel to each other. In addition, the second pair of piezo-resistive devices respond differently to the strain along the primary strain direction 108. Current paths of the second pair of piezo-resistive devices may be arranged similar to the first pair of piezo-resistive devices described in connection with FIG. 2A.

As a result of the two pairs of piezo-resistive devices having different majority carriers, a <5,12,0> crystal direction of the force sensor chip may be aligned within +/−35° to a line that is parallel to the primary strain direction 108. In some implementations, the <5,12,0> crystal direction of the force sensor chip may be aligned within +/−20°, within +/−15°, or within +/−10° to a line that is parallel to the primary strain direction 108. In some implementations, the <5,12,0> crystal direction of the force sensor chip is aligned with the line that is parallel to the primary strain direction 108. Both pairs of piezo-resistive devices may be equally sensitive to the strain along the primary strain direction 108 when the <5,12,0> crystal directions of the force sensor chip are parallel to the primary strain direction 108. Thus, an orientation of the force sensor chip in sensor system 300 is different from an orientation of the force sensor chip in sensor system 100A and is different from an orientation of the force sensor chip in sensor system 200A. For example, the force sensor chip may be aligned between the <100> and <110> crystal directions. As a result, both types of piezo-resistive devices of different majority carriers respond to the strain along the primary strain direction 108. At a component level, the force sensor chip may include a combination of circuitry of the force sensor chip 100B, shown in FIG. 1B, and circuitry of the force sensor chip 200B, shown in FIG. 2B. The aim is to rotate the p- and n-devices by +/−22.5° around the [001]-axis, if p- and n-systems are both used.

The measurement circuit may measure the external mechanical force applied to the strain body 104 based on one or more first currents flowing through the first pair of piezo-resistive devices, and based on one or more second currents flowing through the second pair of piezo-resistive devices. For example, the measurement circuit may receive electric potential Voutp and electric potential Voutn, and calculate the strain and/or the external mechanical force based on the electric potentials Voutp, Voutn and one or more predefined formulas. The measurement circuit may include a nonvolatile memory to store calibration data and/or configuration data and/or identification data of the force sensor chip and/or circuit.

They integration of both types of piezo-resistive devices on a single chip may improve the accuracy of relative alignment between both devices of a pair and between both n- and p-pairs. All piezo-resistive devices should be placed in an interior of the chip top surface—not along an annular peripheral ring with a width approximately equal to the thickness of the chip, because in this annular ring the mechanical stress/strain is reduced and/or inhomogeneous and poorly controlled due to edge effects.

In case the system uses both p- and n-systems, the alignment of the cubic semiconductor crystal may be arbitrary. The +/−22.5° is one possible choice to obtain similar responses of p- and n-systems to the first principal strain ε1, but the force sensor chip may be aligned mainly with <100> parallel to the first principal strain ε1, in which case the n-system has a large response to the first principal strain ε1 and the p-system has only a tiny response. Alternatively, the force sensor chip may be aligned mainly with <110> parallel to the first principal strain ε1 such that the p-system has a strong response to the first principal strain ε1 and the n-system has only a tiny response. Thus, if the system has both p- and n-piezoresistive pairs, the alignment may be arbitrary, because the system can determine the alignment by comparing responses of the p- and n-subsystems. The p- and n-subsystems may be operated simultaneously, or may be multiplexed shortly one after the other.

In some implementations, the external mechanical force applied to the strain body 104 may be measured based solely on the first pair of piezo-resistive devices (e.g., solely based on Voutp), or may be measured solely based on the second pair of piezo-resistive devices (e.g., solely based on Voutn).

Additionally, or alternatively, the output of the second pair of piezo-resistive devices may be used to check a validity (or reliability) of the output of the first pair of piezo-resistive devices, or the output of the first pair of piezo-resistive devices may be used to check a validity (or reliability) of the output of the second of piezo-resistive devices. For example, the measurement circuit may calculate a first strain value based on the electric potential Voutn and a first equation, calculate a second strain value based on the electric potential Voutp and a second equation, and calculate a difference between the first strain value and the second strain value to ensure that the difference does not exceed a threshold. If the difference exceeds the threshold, the measurement circuit may detect an error.

Additionally, or alternatively, the measurement circuit may detect a delamination of the force sensor chip from the strain body based on the electric potential Voutn and/or the electric potential Voutp. For example, multiple sensor pairs of piezo-resistive devices may be placed in different locations on the strain body. If the force sensor chip delaminates, it means that there is a void in the die attach layer 106 and the sensor pair above this void will detect notably different stress/strain than all other sensor pairs. Thus, the measurement circuit may monitor the stress/strain of all sensor pairs and detect a delamination based on any of the sensor pairs detecting a notably different stress/strain than all other sensor pairs (e.g., if the stress/strain deviates from a mean of the other sensor pairs by a threshold amount).

Additionally, or alternatively, the measurement circuit may monitor a magnitude of the electric potential Voutn and/or the electric potential Voutp, compare the magnitude with a threshold, and generate a force-out-of-range signal to indicate that the magnitude has exceeded the threshold.

Additionally, or alternatively, the measurement circuit may monitor a rate of change of the electric potential Voutn and/or the electric potential Voutp, compare the rate of change with a threshold, and generate a fast threshold detection signal to indicate that an abrupt force has occurred.

Additionally, or alternatively, the <5,12,0> crystal directions of the force sensor chip and the line that is parallel to the primary strain direction 108 may be misaligned. Thus, the measurement circuit may use both the electric potential Voutn and the electric potential Voutp to calculate the strain and/or the external mechanical force to compensate for the misalignment. For example, the measurement circuit may combine the readouts of the electric potential Voutn and the electric potential Voutp by deriving an external mechanical force from each readout, and combining both external mechanical forces by adding the external mechanical forces with appropriate coefficients to calculate a final result (e.g., a total external mechanical force). In other words, the system can use Voutn to estimate the strain in direction and Voutp to estimate the strain in [110] direction, and then it can use these two results to compute the primary strain ε1 in the (001)-plane with an unknown direction. Mathematically, this is a system of two equations for the two unknowns ε1 and its direction in the (001)-plane. The unknown direction is basically given by construction, yet it may suffer from small misalignment tolerances. If the system detects a too large deviation of the direction from is target value given by construction, it may issue an alarm “malfunction.”

The measurement circuit may extract a value of the strain along the primary strain direction based on combining information derived from the one or more first currents flowing through the first pair of piezo-resistive devices and information derived from the one or more second currents flowing through the second pair of piezo-resistive devices. The value of the strain may be a) a magnitude b) a magnitude and sign (e.g., to indicate whether the strain relates to a compression or a tension) c) a magnitude and a direction. Combining the information may include performing a calculation in a digital processor or combining signals in an analog circuit. In particular, the combining could be in the analytical manner such that the measurement circuit can use Voutn to estimate the strain in direction and Voutp to estimate the strain in direction, and then the measurement circuit can use these two results to compute the primary strain ε1 in the (001)-plane with an unknown direction.

In some implementations, another device may extract a value of the strain along the primary strain direction based on combining information derived from the one or more first currents flowing through the first pair of piezo-resistive devices and information derived from the one or more second currents flowing through the second pair of piezo-resistive devices.

Suppose a force sensor chip with its edges along x- and y-axes of a coordinate system and its thickness direction along the z-axis of the coordinate system. The axes x,y,z are mutually perpendicular. The force sensor chip comprises a first and a second pair of piezo-resistive devices. The force sensor chip derives the difference of in-plane normal strains, epsXX-epsYY, from a measurement signal of the first pair of piezo-resistive devices, and the force sensor chip derives the in-plane normal strain, epsXY, from a measurement signal of the second pair of piezo-resistive devices. Then, the force sensor chip derives the magnitude of the strain in the primary strain direction, eps1, according to:

$$\vert eps 1 \vert = sqrt \{ ( eps XX - epsYY ) \hat{} 2 + ( 2 * epsXY ) \hat{} 2 \}$$

Additionally, it may derive the primary strain direction, phi1, according to:

$$phi 1 = Arc tan 2 \{ epsXX - epsYY ; 2 * epsXY \}$$

where phi1 is the angle between the primary strain direction and the x-axis, and Arctan2{a;b} is the angle between vectors a*nx+b*ny and nx, whereby nx, ny are the unit vectors in x- and y-direction.

Suppose, the force sensor chip is mounted on the deformation body with such an alignment that the angle between the primary strain direction and the x-axis is phi10. Then, the system can compare phi10 with phi1—small difference are unavoidable due to manufacturing tolerances, but large differences may be interpreted by the system as an error. Moreover, if pih1-phi10 is in the interval (−90°, 90°) the system may interpret the applied force as compressive, and if phi1-phi10 is outside the interval (−90°, 90°) the system may interpret the applied force as tensile. Thus, from the magnitude of the strain in the primary strain direction, |eps1|, the system may derive the magnitude of the applied force, and. from the difference phi1-phi10. the system may derive the sign of the applied force (e.g., push or pull).

Thus, the force sensor chip may provide a diverse sensing system that does not rely on a single type of piezo-resistive device.

As indicated above, FIG. 3 is provided as an example. There the chip edges are rotated by +/−45° against the direction 108 of primary strain ε1. Other examples may differ from what is described with regard to FIG. 3.

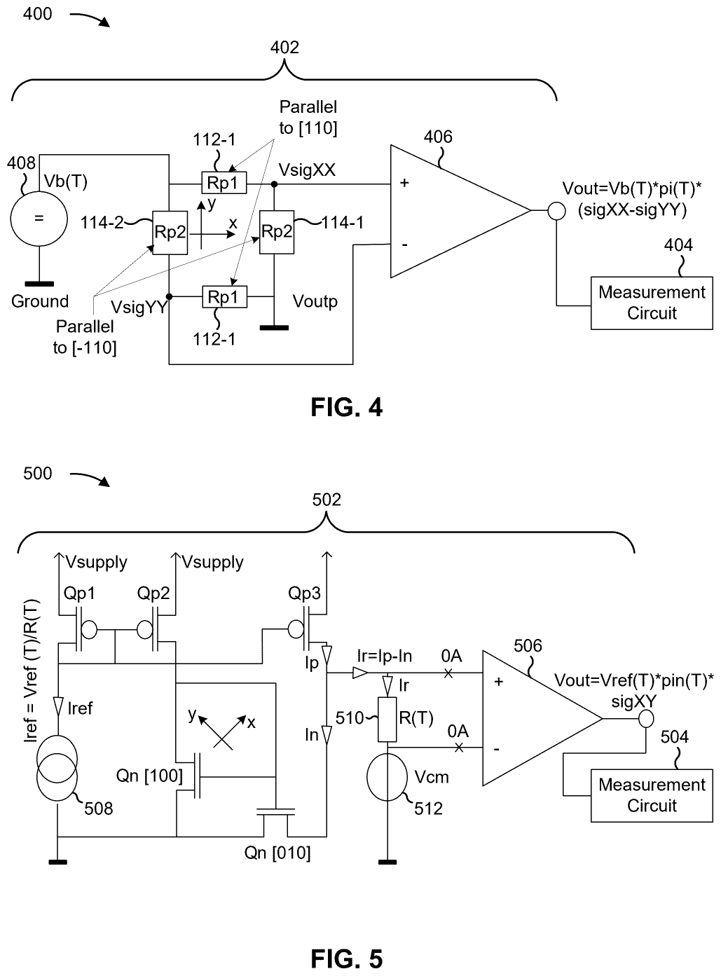

FIG. 4 illustrates a force sensor 400 according to one or more implementations. The force sensor 400 includes a sensor circuit 402 integrated on a force sensor chip (e.g., force sensor chip 100B) and a measurement circuit 404 coupled to a sensor output of the sensor circuit 402 to readout an electric potential Vout. The measurement circuit 404 may be integrated in the force sensor chip or in a separate chip. The force sensor chip may be made of a cubic semiconductor single crystal, where the cubic semiconductor single crystal is configured to undergo a chip deformation based on an external mechanical force applied to a deformable member, such as a strain body, to which the force sensor chip is configured to be mechanically coupled in such a way as to couple the external mechanical force to the cubic semiconductor single crystal to strain the cubic semiconductor single crystal mainly along a primary strain direction (e.g., along an x-axis). Thus, the force sensor chip may be mechanically coupled to the deformable member in such a way as to couple the external mechanical force to the force sensor chip to strain the force sensor chip mainly along the primary strain direction. The x-axis and a y-axis are parallel to <110> crystal directions of the cubic semiconductor single crystal.

The sensor circuit 402 may include a first pair of piezo-resistive devices 112-1, 114-2 and a second pair of piezo-resistive devices 112-2, 114-2, as similarly described in connection with FIGS. 1A and 1B. The first pair of piezo-resistive devices 112-1, 114-2 and the second pair of piezo-resistive devices 112-2, 114-2 may be coupled in a Wheatstone bridge configuration. For example, the first pair of piezo-resistive devices 112-1, 114-2 may be a first pair of orthogonal lateral piezo-resistors, and the second pair of piezo-resistive devices 112-2, 114-2 may be a second pair of orthogonal lateral piezo-resistors. The first pair of piezo-resistive devices 112-1, 114-2 may form a first half-bridge of a Wheatstone bridge, and the second pair of piezo-resistive devices 112-2, 114-2 may form a second half-bridge of a Wheatstone bridge. The first half-bridge may generate a first electric potential VsigXX and the second half-bridge may generate a second electric potential VsigYY.

The sensor circuit 402 may include a differential amplifier 406 that receives the first electric potential VsigXX and the second electric potential VsigYY, amplifies a difference between the first electric potential VsigXX and the second electric potential VsigYY, and provides the electric potential Vout. The electric potential Vout may be proportional to the difference between the first electric potential VsigXX and the second electric potential VsigYY and consequently Vout may be proportional to the difference of in-plane stress components sigXX−sigYY.

The sensor circuit 402 may include a temperature-dependent voltage supply 408 that provides a voltage Vb(T) to generate continuous currents through the Wheatstone bridge. The temperature-dependent voltage supply 408 may provide the voltage Vb(T) based on an ambient temperature such that the electric potential Vout is compensated for the ambient temperature. In other words, the voltage Vb(T) may be adjusted based on changes to the ambient temperature. Thus, the electric potential Vout may equal g×Vb(T)×pi(T)×(sigXX−sigYY), where g is a gain of the differential amplifier 406, and pi(T) is a temperature-dependent piezo-resistive coefficient of the piezo-resistive devices. The measurement circuit 404 may measure the external mechanical force applied to the deformable member based on a differential output (e.g., an electric potential difference) of the Wheatstone bridge.

As indicated above, FIG. 4 is provided as an example. Other examples may differ from what is described with regard to FIG. 4. For example, n-doped piezo-resistive devices, as similarly described in FIGS. 2A and 2B, may be used instead of p-doped piezo-resistive devices. Alternatively, piezo-resistive MOSFETS may be used, as described herein.

FIG. 5 illustrates a force sensor 500 according to one or more implementations. The force sensor 500 includes a sensor circuit 502 integrated on a force sensor chip (e.g., force sensor chip 100B or 200B) and a measurement circuit 504 coupled to a sensor output of the sensor circuit 402 to readout an electric potential Vout. The measurement circuit 504 may be integrated in the force sensor chip or in a separate chip. The force sensor chip may be made of a cubic semiconductor single crystal, where the cubic semiconductor single crystal is configured to undergo a chip deformation based on an external mechanical force applied to a deformable member, such as a strain body, to which the force sensor chip is configured to be mechanically coupled in such a way as to couple the external mechanical force to the cubic semiconductor single crystal to strain the cubic semiconductor single crystal mainly along a primary strain direction (e.g., along an x-axis). Thus, the force sensor chip may be mechanically coupled to the deformable member in such a way as to couple the external mechanical force to the force sensor chip to strain the force sensor chip mainly along the primary strain direction. The x-axis and a y-axis are parallel to <110> crystal directions of the cubic semiconductor single crystal.

A first pair of piezo-resistive devices may include MOSFETS Qn[100] and Qn[010]. The MOSFETS Qn[100] and Qn[010] may be coupled to form a stress-dependent current mirror. The drain-source current paths of the MOSFETS Qn[100] and Qn[010] may be +/−45° to x- and y-axes, respectively. The sensor circuit 502 may include a differential amplifier 506 and a temperature-dependent current supply 508 (e.g., current source). The differential amplifier 506 may generate an electric potential Vout based on an electric potential difference at input terminals of the differential amplifier 506. The temperature-dependent current supply 508 may generate a current Iref based on a temperature-dependent voltage Vref(T). Thus, the current Iref may be adjusted based on changes in an ambient temperature. The temperature-dependent voltage Vref(T) may be generated by a bandgap circuit (not illustrated). A resistance R(T) in Iref=Vref/R(T) may have a same temperature dependence as resistor 510 (e.g., R(T)) that is coupled between at the input terminals of the differential amplifier 506 such that the temperature dependencies cancel out in the electric potential Vout.

The sensor circuit 502 may also include MOSFETS Qp1, Qp2, and Qp3, and a common-mode voltage (Vcm) source 512.

All currents, including current Iref, current Ip, current In, and current Ir flow from Vsupply to ground. The temperature-dependent current supply 508 pulls out a current from MOSFET Qp1. Since MOSFETS Qp1, Qp2, and Qp3 have a same gate potential, identical currents flow through MOSFETs Qp1, Qp2, and Qp3, assuming that MOSFETs Qp1, Qp2, and Qp3 have identical sizes. MOSFETs Q2 and Q3 act like current sources. The current from MOSFETs Q2 flows through MOSFET Qn[100]. At zero strain/stress, a same current flows through Qn[010], and Qn[010] also acts like a current source. In other words, at zero strain/stress, current In is equal to a current flowing through MOSFET Qn[100].

MOSFET Qp3 is configured to push current down and MOSFET Qn[010] is configured to sink current down. At zero stress, currents Ip and In are identical. Therefore, no current flows over resistor 510 and Vout is equal to zero. At non-zero stress, the MOSFET Qn[010] sinks more current than MOSFET Qp3 wants to push, and a difference in current is pulled over resistor 510, which causes a non-zero voltage difference (e.g., a voltage drop) across the input terminals of the differential amplifier 506. The voltage difference may be equal to R(T)×Ir, where Ir=Ip−In. Thus, current Ir is a difference of the current Ip pushed down from MOSFET Qp3 and the current In sunk by MOSFET Qn[010]. A current mirror ratio of Qn[100]/Qn[010] depends on sigXY, which is an in-plane shear-stress. By choosing the temperature dependence of Vref(T) appropriately, Vref(T)×pin(T) may be constant over temperature, with pin (T) being a temperature-dependent piezo-resistive coefficient of the MOSFETs Qn[100] and Qn[010].

The piezo-resistive devices of the pair of piezo-resistive devices have current flows in two perpendicular directions, which may be [100] and [010] or [110] and [−110]. Yet it may also be one arbitrary direction in the (001)-plane and the vertical direction [001]. This holds for resistors and also for MOSFETs. A preferred solution may use two orthogonal directions in the (001)-plane, i.e., it avoids the vertical (001)-direction, because the matching between two devices with lateral current flow is better than the matching of lateral and vertical current flow devices. Nevertheless, one piezo-resistive device may have lateral current flow, and the other piezo-resistive device may have vertical current flow.

As indicated above, FIG. 5 is provided as an example. Other examples may differ from what is described with regard to FIG. 5. For example, P-MOSFETs may be used instead of N-MOSFETS for the stress-dependent current mirror, with drain-source current paths aligned as described in FIGS. 1A and 1B.

The following provides an overview of some Aspects of the present disclosure:

Aspect 1: A sensor system, comprising: a force sensor comprising: a force sensor chip made of a cubic semiconductor single crystal; and a measurement circuit; and a strain body configured to undergo a body deformation in response to an external mechanical force applied to the strain body, wherein the strain body is mechanically coupled to the force sensor chip in such a way as to couple the external mechanical force to the force sensor chip to strain the force sensor chip mainly along a primary strain direction, wherein the force sensor chip comprises: a first pair of piezo-resistive devices integrated in the force sensor chip, wherein the first pair of piezo-resistive devices are arranged such that first current paths through the first pair of piezo-resistive devices are not parallel or anti-parallel to each other, and wherein the first pair of piezo-resistive devices are configured to respond differently to a strain along the primary strain direction, wherein the measurement circuit is configured to measure the external mechanical force based on one or more currents flowing through the first pair of piezo-resistive devices, and wherein each piezo-resistive device of the first pair of piezo-resistive devices has holes as majority carriers, and a <110> crystal direction of the force sensor chip is aligned within +/−35° to a line that is parallel to the primary strain direction, or wherein each piezo-resistive device of the first pair of piezo-resistive devices has electrons as the majority carriers, and a <100> crystal direction of the force sensor chip is aligned within +/−35° to the line that is parallel to the primary strain direction.

Aspect 2: The sensor system of Aspect 1, wherein the measurement circuit is integrated in the force sensor chip and/or the force sensor chip comprises non-volatile memory storing information on at least one electric parameter of the first pair of piezo-resistive devices.

Aspect 3: The sensor system of any of Aspects 1-2, further comprising: a die attach layer configured to mechanically couple the force sensor chip to the strain body.

Aspect 4: The sensor system of any of Aspects 1-3, wherein either the <100> crystal directions or the <110> crystal directions of the force sensor chip are parallel or antiparallel to chip edges of the force sensor chip.

Aspect 5: The sensor system of any of Aspects 1-4, wherein the first pair of piezo-resistive devices, which have holes as majority carriers, are p-doped devices, and wherein the first pair of piezo-resistive devices, which have electrons as majority carriers, are n-doped devices.

Aspect 6: The sensor system of any of Aspects 1-5, wherein the first pair of piezo-resistive devices are piezo-resistors.

Aspect 7: The sensor system of Aspect 6, wherein the first pair of piezo-resistive devices includes a first p-doped piezo-resistor configured to conduct a current mainly in a crystal direction of the force sensor chip, and a second p-doped piezo-resistor configured to conduct the current mainly in a [−110] crystal direction of the force sensor chip, or wherein the first pair of piezo-resistive devices includes a first n-doped piezo-resistor configured to conduct the current mainly in a [100] crystal direction of the force sensor chip, and a second n-doped piezo-resistor configured to conduct the current mainly in a [010] crystal direction of the force sensor chip.

Aspect 8: The sensor system of Aspect 6, wherein the first pair of piezo-resistive devices form a voltage divider configured to generate an electric potential at a node coupled between the first pair of piezo-resistive devices, and the measurement circuit is configured to measure the external mechanical force based on the electric potential. There are numerous ways to measure the ratio or difference of the resistances of the two resistors of the piezo-resistive pair, besides the half-bridge or full Wheatstone bridge. One alternative is to use two current sources, each one injects its current into one of the two resistors. The other nodes of the resistors are at ground. Thus, the potentials at the injection nodes are proportional to the resistance of the piezo-resistors. These two nodes can be connected to inverting and noninverting inputs of the amplifier 406 in FIG. 4. A third way is to use both resistors as feedback resistors of an inverting or a non-inverting OpAmp. A reference voltage is fed to the inputs of these amplifier circuits, and the output is again a function of the ratio of both piezo-resistors.

Aspect 9: The sensor system of any of Aspects 1-8, wherein the first pair of piezo-resistive devices are transistors.

Aspect 10: The sensor system of Aspect 9, wherein the first pair of piezo-resistive devices includes a first p-transistor configured to conduct a first current in a first <110> crystal direction of the force sensor chip, and a second p-transistor configured to conduct a second current in a direction orthogonal to the first <110> crystal direction of the force sensor chip, or wherein the first pair of piezo-resistive devices includes a first n-transistor configured to conduct the first current in a first <100> crystal direction of the force sensor chip, and a second n-transistor configured to conduct the second current in a direction orthogonal to the first <100> crystal direction of the force sensor chip.

Aspect 11: The sensor system of Aspect 9, wherein the first pair of piezo-resistive devices includes a first p-transistor configured to conduct a first current, and a second p-transistor configured to conduct a second current, and wherein the measurement circuit is configured to determine the external mechanical force based on a ratio of the first current and the second current or based on a difference between the first current and the second current.

Aspect 12: The sensor system of Aspect 11, wherein the first pair of piezo-resistive devices form a current mirror or a differential input pair.

Aspect 13: The sensor system of any of Aspects 1-12, further comprising: a temperature-dependent power supply coupled to the first pair of piezo-resistive devices, wherein the temperature-dependent power supply is configured to provide a supply voltage or a supply current based on an ambient temperature such that a measure of the external mechanical force is compensated for the ambient temperature.

Aspect 14: The sensor system of any of Aspects 1-13, further comprising: a second pair of piezo-resistive devices integrated in the force sensor chip, wherein the second pair of piezo-resistive devices are arranged such that second current paths through the second pair of piezo-resistive devices are not parallel or anti-parallel to each other, and wherein the second pair of piezo-resistive devices respond differently to the strain along the primary strain direction, wherein the first pair of piezo-resistive devices and the second pair of piezo-resistive devices are coupled in a Wheatstone bridge configuration, wherein the first pair of piezo-resistive devices are a first pair of orthogonal lateral piezo-resistors, and wherein the second pair of piezo-resistive devices are a second pair of orthogonal lateral piezo-resistors.

Aspect 15: The sensor system of any of Aspects 1-14, wherein the strain body has a length dimension and a width dimension, and wherein the primary strain direction extends along the length dimension.

Aspect 16: The sensor system of Aspect 15, wherein the width dimension and the length dimension define a lateral chip plane of the force sensor chip, and wherein the first current paths are aligned with the lateral chip plane.

Aspect 17: The sensor system of any of Aspects 1-16, wherein the strain body is mechanically coupled to the force sensor chip in such a way that the body deformation causes a largest principal strain component of the force sensor chip to occur along the primary strain direction.

Aspect 18: The sensor system of any of Aspects 1-17, wherein the first current paths are parallel to a {100} plane of the force sensor chip.

Aspect 19: A sensor system, comprising: a force sensor chip made of a cubic semiconductor single crystal; and a strain body configured to undergo a body deformation in response to an external mechanical force applied to the strain body, wherein the strain body is mechanically coupled to the force sensor chip in such a way as to couple the external mechanical force to the force sensor chip to strain the force sensor chip mainly along a primary strain direction, wherein the force sensor chip comprises: a first pair of piezo-resistive devices integrated in the force sensor chip, wherein the first pair of piezo-resistive devices are arranged such that first current paths through the first pair of piezo-resistive devices are not parallel or anti-parallel to each other, and wherein the first pair of piezo-resistive devices respond differently to a strain along the primary strain direction; a second pair of piezo-resistive devices integrated in the force sensor chip, wherein the second pair of piezo-resistive devices are arranged such that second current paths through the second pair of piezo-resistive devices are not parallel or anti-parallel to each other, and wherein the second pair of piezo-resistive devices respond differently to the strain along the primary strain direction; and a measurement circuit configured to measure the external mechanical force based on at least one of: one or more first currents flowing through the first pair of piezo-resistive devices, or one or more second currents flowing through the second pair of piezo-resistive devices, wherein each piezo-resistive device of the first pair of piezo-resistive devices has holes as majority carriers, wherein each piezo-resistive device of the second pair of piezo-resistive devices has electrons as the majority carriers.

Aspect 20: The sensor system according to Aspect 19, wherein a <5,12,0> crystal direction of the force sensor chip is aligned within +/−35° to a line that is parallel to the primary strain direction.

Aspect 21: The sensor system according to any of Aspects 19-20, further comprising: a device to extract a value of the strain along the primary strain direction based on combining information derived from the one or more first currents flowing through the first pair of piezo-resistive devices and information derived from the one or more second currents flowing through the second pair of piezo-resistive devices.

Aspect 22: A force sensor chip, comprising: a cubic semiconductor single crystal, wherein the cubic semiconductor single crystal is configured to undergo a chip deformation based on an external mechanical force applied to a deformable member to which the force sensor chip is configured to be mechanically coupled in such a way as to couple the external mechanical force to the cubic semiconductor single crystal to strain the cubic semiconductor single crystal mainly along a primary strain direction; a first pair of piezo-resistive devices integrated in the cubic semiconductor single crystal, wherein the first pair of piezo-resistive devices are arranged such that first current paths through the first pair of piezo-resistive devices are not parallel or anti-parallel to each other, and wherein the first pair of piezo-resistive devices respond differently to an in-plane mechanical strain caused by a chip deformation of the cubic semiconductor single crystal; and a measurement circuit configured to measure the external mechanical force based on one or more currents flowing through the first pair of piezo-resistive devices, wherein each piezo-resistive device of the first pair of piezo-resistive devices has holes as majority carriers, and a <110> crystal direction of the cubic semiconductor single crystal is configured to be aligned within +/−35° to a line that is parallel to the primary strain direction, or wherein each piezo-resistive device of the first pair of piezo-resistive devices has electrons as the majority carriers, and a <100> crystal direction of the cubic semiconductor single crystal is configured to be aligned within +/−35° to the line that is parallel to the primary strain direction.

Aspect 23: A force sensor chip, comprising: a cubic semiconductor single crystal, wherein the cubic semiconductor single crystal is configured to undergo a chip deformation based on an external mechanical force applied to a deformable member to which the force sensor chip is configured to be mechanically coupled in such a way as to couple the external mechanical force to the cubic semiconductor single crystal to strain the cubic semiconductor single crystal mainly along a primary strain direction; a first pair of piezo-resistive devices integrated in the cubic semiconductor single crystal, wherein the first pair of piezo-resistive devices are arranged such that first current paths through the first pair of piezo-resistive devices are not parallel or anti-parallel to each other, and wherein the first pair of piezo-resistive devices respond differently to an in-plane mechanical strain caused by the chip deformation; a second pair of piezo-resistive devices integrated in the cubic semiconductor single crystal, wherein the second pair of piezo-resistive devices are arranged such that second current paths through the second pair of piezo-resistive devices are not parallel or anti-parallel to each other, and wherein the second pair of piezo-resistive devices respond differently to the in-plane mechanical strain caused by a chip deformation of the cubic semiconductor single crystal; and a measurement circuit configured to measure the external mechanical force based on one or more first currents flowing through the first pair of piezo-resistive devices, and based on one or more second currents flowing through the second pair of piezo-resistive devices, wherein each piezo-resistive device of the first pair of piezo-resistive devices has holes as majority carriers, wherein each piezo-resistive device of the second pair of piezo-resistive devices has electrons as the majority carriers.

Aspect 24: The force sensor chip of Aspect 23, wherein a <5,12,0> crystal direction of the cubic semiconductor single crystal is configured to be aligned within +/−35° to a line that is parallel to the primary strain direction.

Aspect 25: A system configured to perform one or more operations recited in one or more of Aspects 1-24.

Aspect 26: An apparatus comprising means for performing one or more operations recited in one or more of Aspects 1-24.

Aspect 27: A non-transitory computer-readable medium storing a set of instructions, the set of instructions comprising one or more instructions that, when executed by a device, cause the device to perform one or more operations recited in one or more of Aspects 1-24.

Aspect 28: A computer program product comprising instructions or code for executing one or more operations recited in one or more of Aspects 1-24.

The foregoing disclosure provides illustration and description, but is not intended to be exhaustive or to limit the implementations to the precise form disclosed. Modifications and variations are possible in light of the above disclosure or may be acquired from practice of the implementations.

Some implementations may be described herein in connection with thresholds. As used herein, “satisfying” a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

As used herein, the term “component” is intended to be broadly construed as hardware, firmware, or a combination of hardware and software. It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Any of the processing components may be implemented as a central processing unit (CPU) or other processor reading and executing a software program from a non-transitory computer-readable recording medium such as a hard disk or a semiconductor memory device. For example, instructions may be executed by one or more processors, such as one or more CPUs, digital signal processors (DSPs), general-purpose microprocessors, application-specific integrated circuits (ASICs), field programmable logic arrays (FPLAs), programmable logic controller (PLC), or other equivalent integrated or discrete logic circuitry. Accordingly, the term “processor,” as used herein refers to any of the foregoing structures or any other structure suitable for implementation of the techniques described herein. Software may be stored on a non-transitory computer-readable medium such that the non-transitory computer readable medium includes a program code or a program algorithm stored thereon which, when executed, causes the processor, via a computer program, to perform the steps of a method.

A controller including hardware may also perform one or more of the techniques of this disclosure. A controller, including one or more processors, may use electrical signals and digital algorithms to perform its receptive, analytic, and control functions, which may further include corrective functions. Such hardware, software, and firmware may be implemented within the same device or within separate devices to support the various techniques described in this disclosure.

A signal processing circuit and/or a signal conditioning circuit may receive one or more signals (e.g., measurement signals) from one or more components in the form of raw measurement data and may derive, from the measurement signal further information. Signal conditioning, as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation and any other processes required to make a signal suitable for processing after conditioning.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations, a single act may include or may be broken into multiple sub acts. Such sub acts may be included and part of the disclosure of this single act unless explicitly excluded.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A sensor system, comprising:
a force sensor comprising:
a force sensor chip made of a cubic semiconductor single crystal; and
a measurement circuit; and
a strain body configured to undergo a body deformation in response to an external mechanical force applied to the strain body, wherein the strain body is mechanically coupled to the force sensor chip in such a way as to couple the external mechanical force to the force sensor chip to strain the force sensor chip mainly along a primary strain direction,
wherein the force sensor chip comprises:
a first pair of piezo-resistive devices integrated in the force sensor chip, wherein the first pair of piezo-resistive devices are arranged such that first current paths through the first pair of piezo-resistive devices are not parallel or anti-parallel to each other, and wherein the first pair of piezo-resistive devices are configured to respond differently to a strain along the primary strain direction,
wherein the measurement circuit is configured to measure the external mechanical force based on one or more currents flowing through the first pair of piezo-resistive devices, and
wherein each piezo-resistive device of the first pair of piezo-resistive devices has holes as majority carriers, and a <110> crystal direction of the force sensor chip is aligned within +/−35° to a line that is parallel to the primary strain direction, or
wherein each piezo-resistive device of the first pair of piezo-resistive devices has electrons as the majority carriers, and a <100> crystal direction of the force sensor chip is aligned within +/−35° to the line that is parallel to the primary strain direction.

2. The sensor system of claim 1, wherein the measurement circuit is integrated in the force sensor chip and/or the force sensor chip comprises non-volatile memory storing information on at least one electric parameter of the first pair of piezo-resistive devices.

3. The sensor system of claim 1, further comprising:
a die attach layer configured to mechanically couple the force sensor chip to the strain body.

4. The sensor system of claim 1, wherein either the <100> crystal directions or the <110> crystal directions of the force sensor chip are parallel or antiparallel to chip edges of the force sensor chip.

5. The sensor system of claim 1, wherein the first pair of piezo-resistive devices, which have holes as majority carriers, are p-doped devices, and
wherein the first pair of piezo-resistive devices, which have electrons as majority carriers, are n-doped devices.

6. The sensor system of claim 1, wherein the first pair of piezo-resistive devices are piezo-resistors.

7. The sensor system of claim 6, wherein the first pair of piezo-resistive devices includes a first p-doped piezo-resistor configured to conduct a current in a [110] crystal direction of the force sensor chip, and a second p-doped piezo-resistor configured to conduct the current in a [−110] crystal direction of the force sensor chip, or
wherein the first pair of piezo-resistive devices includes a first n-doped piezo-resistor configured to conduct the current in a [100] crystal direction of the force sensor chip, and a second n-doped piezo-resistor configured to conduct the current in a [010] crystal direction of the force sensor chip.

8. The sensor system of claim 6, wherein the first pair of piezo-resistive devices form a voltage divider configured to generate an electric potential at a node coupled between the first pair of piezo-resistive devices, and
the measurement circuit is configured to measure the external mechanical force based on the electric potential.

9. The sensor system of claim 1, wherein the first pair of piezo-resistive devices are transistors.

10. The sensor system of claim 9, wherein the first pair of piezo-resistive devices includes a first p-transistor configured to conduct a first current in a first <110> crystal direction of the force sensor chip, and a second p-transistor configured to conduct a second current in a direction orthogonal to the first <110> crystal direction of the force sensor chip, or
wherein the first pair of piezo-resistive devices includes a first n-transistor configured to conduct the first current in a first <100> crystal direction of the force sensor chip, and a second n-transistor configured to conduct the second current in a direction orthogonal to the first <100> crystal direction of the force sensor chip.

11. The sensor system of claim 9, wherein the first pair of piezo-resistive devices includes a first p-transistor configured to conduct a first current, and a second p-transistor configured to conduct a second current, and
wherein the measurement circuit is configured to determine the external mechanical force based on a ratio of the first current and the second current or based on a difference between the first current and the second current.

12. The sensor system of claim 11, wherein the first pair of piezo-resistive devices form a current mirror or a differential input pair.

13. The sensor system of claim 1, further comprising:
a temperature-dependent power supply coupled to the first pair of piezo-resistive devices, wherein the temperature-dependent power supply is configured to provide a supply voltage or a supply current based on an ambient temperature such that a measure of the external mechanical force is compensated for the ambient temperature.

14. The sensor system of claim 1, further comprising:
a second pair of piezo-resistive devices integrated in the force sensor chip, wherein the second pair of piezo-resistive devices are arranged such that second current paths through the second pair of piezo-resistive devices are not parallel or anti-parallel to each other, and wherein the second pair of piezo-resistive devices respond differently to the strain along the primary strain direction,
wherein the first pair of piezo-resistive devices and the second pair of piezo-resistive devices are coupled in a Wheatstone bridge configuration,
wherein the first pair of piezo-resistive devices are a first pair of orthogonal lateral piezo-resistors, and
wherein the second pair of piezo-resistive devices are a second pair of orthogonal lateral piezo-resistors.

15. The sensor system of claim 1, wherein the strain body has a length dimension and a width dimension, and
wherein the primary strain direction extends along the length dimension.

16. The sensor system of claim 15, wherein the width dimension and the length dimension define a lateral chip plane of the force sensor chip, and
wherein the first current paths are aligned with the lateral chip plane.

17. The sensor system of claim 1, wherein the strain body is mechanically coupled to the force sensor chip in such a way that the body deformation causes a largest principal strain component of the force sensor chip to occur along the primary strain direction.

18. The sensor system of claim 1, wherein the first current paths are parallel to a {100} plane of the force sensor chip.

19. A sensor system, comprising:
a force sensor chip made of a cubic semiconductor single crystal; and
a strain body configured to undergo a body deformation in response to an external mechanical force applied to the strain body, wherein the strain body is mechanically coupled to the force sensor chip in such a way as to couple the external mechanical force to the force sensor chip to strain the force sensor chip mainly along a primary strain direction,
wherein the force sensor chip comprises:
a first pair of piezo-resistive devices integrated in the force sensor chip, wherein the first pair of piezo-resistive devices are arranged such that first current paths through the first pair of piezo-resistive devices are not parallel or anti-parallel to each other, and wherein the first pair of piezo-resistive devices respond differently to a strain along the primary strain direction;
a second pair of piezo-resistive devices integrated in the force sensor chip, wherein the second pair of piezo-resistive devices are arranged such that second current paths through the second pair of piezo-resistive devices are not parallel or anti-parallel to each other, and wherein the second pair of piezo-resistive devices respond differently to the strain along the primary strain direction; and
a measurement circuit configured to measure the external mechanical force based on at least one of:
one or more first currents flowing through the first pair of piezo-resistive devices, or
one or more second currents flowing through the second pair of piezo-resistive devices,
wherein each piezo-resistive device of the first pair of piezo-resistive devices has holes as majority carriers, wherein each piezo-resistive device of the second pair of piezo-resistive devices has electrons as the majority carriers.

20. The sensor system according to claim 19, wherein a <5,12,0> crystal direction of the force sensor chip is aligned within +/−35° to a line that is parallel to the primary strain direction.

21. The sensor system according to claim 19, further comprising:
a device to extract a value of the strain along the primary strain direction based on combining information derived from the one or more first currents flowing through the first pair of piezo-resistive devices and information derived from the one or more second currents flowing through the second pair of piezo-resistive devices.

22. A force sensor chip, comprising:
a cubic semiconductor single crystal, wherein the cubic semiconductor single crystal is configured to undergo a chip deformation based on an external mechanical force applied to a deformable member to which the force sensor chip is configured to be mechanically coupled in such a way as to couple the external mechanical force to the cubic semiconductor single crystal to strain the cubic semiconductor single crystal mainly along a primary strain direction;
a first pair of piezo-resistive devices integrated in the cubic semiconductor single crystal, wherein the first pair of piezo-resistive devices are arranged such that first current paths through the first pair of piezo-resistive devices are not parallel or anti-parallel to each other, and wherein the first pair of piezo-resistive devices respond differently to an in-plane mechanical strain caused by a chip deformation of the cubic semiconductor single crystal; and
a measurement circuit configured to measure the external mechanical force based on one or more currents flowing through the first pair of piezo-resistive devices,
wherein each piezo-resistive device of the first pair of piezo-resistive devices has holes as majority carriers, and a <110> crystal direction of the cubic semiconductor single crystal is configured to be aligned within +/−35° to a line that is parallel to the primary strain direction, or
wherein each piezo-resistive device of the first pair of piezo-resistive devices has electrons as the majority carriers, and a <100> crystal direction of the cubic semiconductor single crystal is configured to be aligned within +/−35° to the line that is parallel to the primary strain direction.

23. A force sensor chip, comprising:
a cubic semiconductor single crystal, wherein the cubic semiconductor single crystal is configured to undergo a chip deformation based on an external mechanical force applied to a deformable member to which the force sensor chip is configured to be mechanically coupled in such a way as to couple the external mechanical force to the cubic semiconductor single crystal to strain the cubic semiconductor single crystal mainly along a primary strain direction;
a first pair of piezo-resistive devices integrated in the cubic semiconductor single crystal, wherein the first pair of piezo-resistive devices are arranged such that first current paths through the first pair of piezo-resistive devices are not parallel or anti-parallel to each other, and wherein the first pair of piezo-resistive devices respond differently to an in-plane mechanical strain caused by the chip deformation;
a second pair of piezo-resistive devices integrated in the cubic semiconductor single crystal, wherein the second pair of piezo-resistive devices are arranged such that second current paths through the second pair of piezo-resistive devices are not parallel or anti-parallel to each other, and wherein the second pair of piezo-resistive devices respond differently to the in-plane mechanical strain caused by a chip deformation of the cubic semiconductor single crystal; and
a measurement circuit configured to measure the external mechanical force based on one or more first currents flowing through the first pair of piezo-resistive devices, and based on one or more second currents flowing through the second pair of piezo-resistive devices,
wherein each piezo-resistive device of the first pair of piezo-resistive devices has holes as majority carriers, wherein each piezo-resistive device of the second pair of piezo-resistive devices has electrons as the majority carriers.

24. The force sensor chip of claim 23, wherein a <5,12,0> crystal direction of the cubic semiconductor single crystal is configured to be aligned within +/−35° to a line that is parallel to the primary strain direction.
